(19) United States
(12) Patent Application Publication
(10) Pub. No.: US 2026/0211303 A1
(43) Pub. Date: Jul. 23, 2026

(54) MOTORIZED GIMBAL AND PHOTOGRAPHIC DEVICE

(71) Applicant: SHENZHEN LEQI INNOVATION CO., LTD., SHENZHEN (CN)

(72) Inventor: WEI TANG, SHENZHEN (CN)

(21) Appl. No.: 19/450,755

(22) Filed: Jan. 16, 2026

(30) Foreign Application Priority Data
Jan. 17, 2025 (CN) 202520115335.1

(51) Int. Cl. G03B 17/56; F16M 11/04; F16M 11/10; F16M 11/18; F16M 11/20

(52) U.S. Cl. CPC G03B 17/561; F16M 11/045; F16M 11/10; F16M 11/18; F16M 11/2014

(57) ABSTRACT

A motorized gimbal is provided, including a base, a carrier assembly, an adjustment mechanism, and a control assembly. The adjustment mechanism includes a first adjustment component, a second adjustment component, and a third adjustment component. The first end of the third adjustment component is connected to the carrier assembly, and the third adjustment component is configured to drive the carrier assembly to rotate horizontally. The first adjustment component is connected to the second end of the third adjustment component and configured to drive the third adjustment component to drive the carrier assembly to perform a pitch motion. The second adjustment component is connected to the first adjustment component and configured to drive the first adjustment component so as to drive the third adjustment component to move in a horizontal direction. The control assembly is configured to control an operating state of at least one of the three adjustment components.

### TECHNICAL FIELD

The present disclosure relates to the technical field of photographic equipment, and in particular, to a motorized gimbal and a photographic device.

### BACKGROUND

A motorized gimbal is a device for supporting a photographic apparatus and adjusting the orientation of the photographic apparatus. The motorized gimbal is widely used in fields including photography, videography, and surveillance. By means of a motor drive and a control assembly, the motorized gimbal can adjust the angle of a photographic apparatus that has been mounted in both horizontal and vertical directions, thereby enabling shooting from various perspectives. Currently, motorized gimbal has multiple operating modes, such as motorized mode and damping mode, to adapt to different usage scenarios.

In the related art, such motorized gimbal typically includes a motor, a transmission mechanism, and a control unit. Control signals are sent to the control unit via physical buttons. After receiving the signals, the control unit controls the motor to adjust the shooting position and angle of the photographic apparatus.

However, the gimbal in the related art has relatively limited functionality and cannot rapidly switch between different operating modes to accommodate varying usage needs.

### SUMMARY

The present disclosure provides a motorized gimbal, which aims to address the issue in the related art that motorized gimbal cannot rapidly switch between different operating modes.

To realize the above objective, the present disclosure provides a motorized gimbal, including:

a base;

a carrier assembly configured to mount a photographic apparatus;

an adjustment mechanism disposed on the base, the adjustment mechanism including a first adjustment component, a second adjustment component, and a third adjustment component including a first end and a second end; where,

the first end of the third adjustment component is connected to the carrier assembly, and the third adjustment component is configured to drive the carrier assembly to rotate in a horizontal direction;

the first adjustment component is connected to the second end of the third adjustment component and configured to drive the third adjustment component to drive the carrier assembly to perform a pitch motion; and

the second adjustment component is connected to the first adjustment component and configured to drive the first adjustment component so as to drive the third adjustment component to move in a horizontal direction; and

a control assembly electrically connected to the first adjustment component, the second adjustment component, and the third adjustment component respectively, the control assembly being configured to control an operating state of at least one selected from a group consisting of the first adjustment component, the second adjustment component, and the third adjustment component.

In some embodiments, the first adjustment component includes a first driving member, a first mounting member, and a second mounting member rotatable relative to the first mounting member. The first driving member is mounted on one of the first mounting member and the second mounting member, and the first driving member includes an actuating end that is connected to the other of the first mounting component and the second mounting component. The first driving member is electrically connected to the control assembly and configured to apply electromagnetic damping to relative rotation between the first mounting member and the second mounting member.

In some embodiments, the second adjustment component includes a second driving member and a third mounting member rotatable relative to the base. The second driving member is mounted on one of the third mounting member and the base, and the second driving member includes an actuating end that is connected to the other of the third mounting component and the base. The second driving member is electrically connected to the control assembly and configured to apply electromagnetic damping to relative rotation between the third mounting member and the base.

In some embodiments, the third adjustment component includes a third driving member and a fourth mounting member. The third driving member is mounted on the fourth mounting member, and the third driving member including an actuating end that is connected to the carrier assembly. The third driving member is electrically connected to the control assembly and configured to apply electromagnetic damping to relative movement between the carrier assembly and the fourth mounting member.

In some embodiments, the control assembly is electrically connected to the first driving member, the second driving member, and the third driving member, respectively. The first driving member is configured to, under control of the control assembly, drive the first mounting member to rotate relative to the second mounting member, to drive the third adjustment component to perform a pitch motion so as to adjust a pitch angle of the photographic apparatus. The second driving member is configured to, under control of the control assembly, drive the relative rotation between the third mounting member and the base, to drive the third adjustment component to perform a horizontal rotation so as to adjust a horizontal angle of the photographic apparatus. The third driving member is configured to, under control of the control assembly, drive the carrier assembly to rotate relative to the fourth mounting member so as to adjust a center of gravity of the photographic apparatus.

In some embodiments, the motorized gimbal further includes a clutch mechanism mounted to the adjustment mechanism. The clutch mechanism is configured to, under action of an external force, establish a transmission connection between the first adjustment component and the third adjustment component, and establish a transmission connection between the second adjustment component and the base; or release a transmission connection between the first adjustment component and the third adjustment component, and release a transmission connection between the second adjustment component and the base. The clutch mechanism includes a first clutch slidably mounted in the first mounting member and fixed relative to the first mounting member in a circumferential direction. The first clutch includes a clutch lever slidable along an axial direction of the actuating end of the first driving member, so as to disengage from or engage with the actuating end of the first driving member.

In some embodiments, the clutch mechanism further includes a second clutch slidably mounted in the base. The second clutch includes a clutch lever slidable along an axial direction of the actuating end of the second driving member, so as to disengage from or engage with the actuating end of the second driving member.

In some embodiments, the motorized gimbal further includes an operation assembly. The operation assembly is disposed on one of the first adjustment component, the second adjustment component, and the third adjustment component; and the operation assembly is electrically connected to the control assembly and configured for a user to operate.

In some embodiments, the control assembly includes a wireless communication module configured to receive an external wireless control signal.

In some embodiments, the wireless communication module includes a signal receive; wherein the signal receive is disposed on the second adjustment component and electrically connected to the control assembly.

The present disclosure further provides a photographic device, including a support frame; a photographic apparatus; and the motorized gimbal according to any one of the foregoing embodiments. One end of the motorized gimbal is connected to the support frame, and the other end of the motorized gimbal is connected to the photographic apparatus.

According to the present disclosure, by means of the adjustment mechanism including the first adjustment component, the second adjustment component, and the third adjustment component, multi-degree-of-freedom adjustment of the carrier assembly is achieved, including pitch, horizontal translation, and horizontal rotation. This enables flexible adjustment of the shooting angle and/or position of the photographic apparatus mounted thereon. Through electrical connections between the control assembly and the adjustment mechanism, the operational states can be controlled based on shooting requirements, enabling free switching between different adjustment modes.

### BRIEF DESCRIPTION OF THE DRAWINGS

FIG. 1 is a schematic structural diagram of a motorized gimbal according to an embodiment of the present disclosure.

FIG. 2 is a schematic structural diagram of a motorized gimbal according to another embodiment of the present disclosure.

FIG. 3 is an enlarged view of portion A in FIG. 2.

FIG. 4 is a side view of a motorized gimbal according to an embodiment of the present disclosure.

FIG. 5 is a cross-sectional view taken along line B-B in FIG. 4.

The realization of the objectives, functional features, and advantages of the present disclosure will be further described in conjunction with the embodiments and with reference to the accompanying drawings.

### DETAILED DESCRIPTION OF THE EMBODIMENTS

The technical solutions in the embodiments of the present disclosure will be described clearly and completely with reference to the accompanying drawings in the embodiments of the present disclosure. Obviously, the described embodiments are only a part of the embodiments of the present disclosure rather than all of them. Based on the embodiments in the present disclosure, all other embodiments obtained by those skilled in the art without creative work shall fall within the scope of protection of the present disclosure.

It should be noted that all directional indications (such as up, down, left, right, front, back) in the embodiments of the present disclosure are merely used to explain relative position relationships or motion conditions between the components in a specific attitude (as shown in the drawings). The directional indication changes as the specific attitude changes.

It should also be noted that when an element is referred to as being “mounted on” or “disposed on” another element, it may be directly on the other element, or intervening elements may also be present. When an element is referred to as being “connected to” another element, it may be directly connected to the other element, or intervening elements may also be present.

Moreover, the terms “first”, “second”, and the like in the present disclosure are merely used for description and cannot be understood as indicating or implying their relative importance or as implicitly indicating the quantity of the technical features indicated. Thus, the feature defined by “first” or “second” may explicitly or implicitly include at least one such feature. In addition, the technical solutions of various embodiments may be combined with each other, but must be based on that the combined technical solutions can be implemented by those skilled in the art. When the combination of the technical solutions is contradictory or impossible to realize, it shall be considered that such combination does not exist and is not within the scope of protection of the present disclosure.

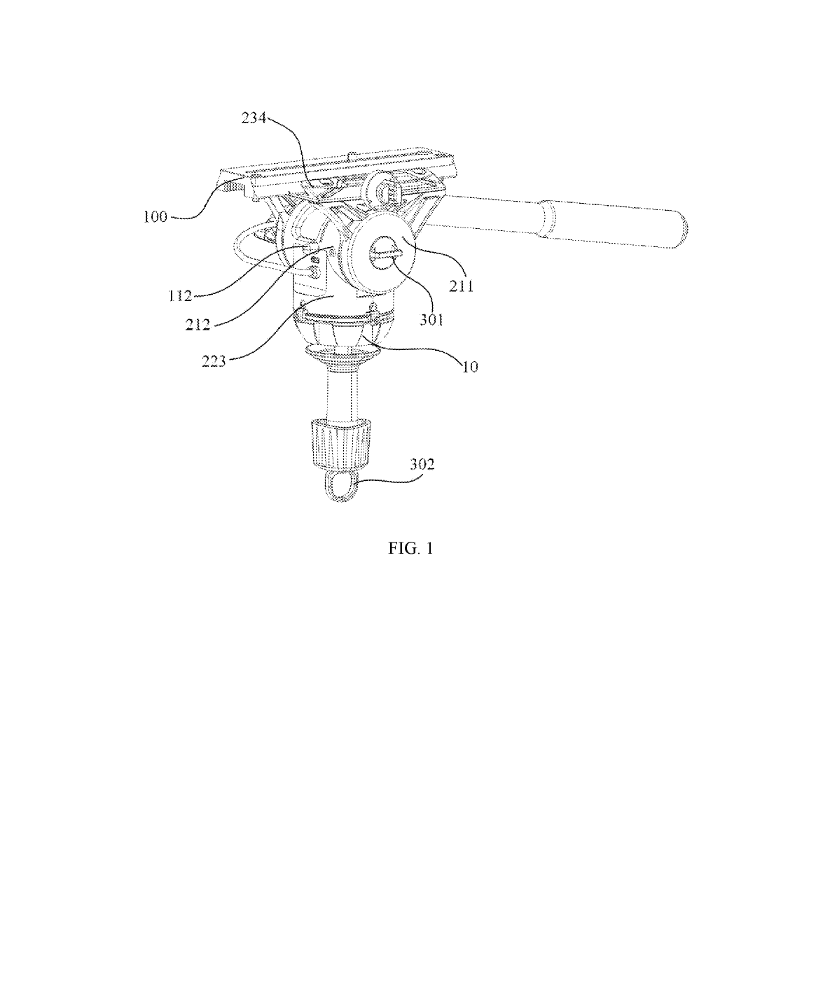

In some embodiments, referring to FIG. 1 to FIG. 3, the present disclosure provides a motorized gimbal, which includes:

a base 10;

a carrier assembly 100, configured to mount a photographic apparatus 600; and

an adjustment mechanism 200 mounted on the base 10, the adjustment mechanism 200 including a first adjustment component 210, a second adjustment component 220, and a third adjustment component 230 including a first end 231 and a second end 232.

The first end 231 of the third adjustment component 230 is connected to the carrier assembly 100, and the third adjustment component 230 is configured to drive the carrier assembly 100 to rotate in a horizontal direction.

The first adjustment component 210 is connected to the second end 232 of the third adjustment component 230, and is configured to drive the third adjustment component 230 to drive the carrier assembly 100 to perform a pitch motion.

The second adjustment component 220 is connected to the first adjustment component 210, and is configured to drive the first adjustment component 210 to drive the third adjustment component 230 to move in the horizontal direction.

The motorized gimbal also includes a control assembly 110 electrically connected to the first adjustment component 210, the second adjustment component 220, and the third adjustment component 230 respectively, and configured to control an operating state of at least one selected from a group consisting of the first adjustment component 210, the second adjustment component 220, and the third adjustment component 230.

In the embodiments, the base 10 serves as the support structure of the entire motorized gimbal. It not only provides stable support for the motorized gimbal but also supplies a mounting reference for the adjustment mechanism 200. The carrier assembly 100 is configured to mount various types of photographic apparatus 600. The carrier assembly 100 may be configured as a standard cold shoe plate structure to accommodate photographic apparatus such as cameras and camcorders of different brands. Alternatively, the carrier assembly 100 may be configured as other forms such as a quick-release plate or a universal base plate, ensuring rapid mounting and secure connection of the photographic apparatus 600.

The adjustment mechanism 200 serves as a core component in the present disclosure. The adjustment mechanism 200 includes the first adjustment component 210, the second adjustment component 220, and the third adjustment component 230, and these three adjustment components can achieve multi-degree-of-freedom motion adjustment under the coordinated control of the control assembly 110. In some embodiments, each of the first adjustment component 210, the second adjustment component 220, and the third adjustment component 230 may be driven by a high-precision motor. By way of a precise mechanical transmission systems, it enables precise position control and speed adjustment following control from the control assembly 110, thereby ensuring smooth motion of the photographic apparatus 600.

During actual operation, the motorized gimbal can flexibly switch between a plurality of operating modes. In a motorized mode, the first adjustment component 210, the second adjustment component 220, and the third adjustment component 230 work cooperatively. The first adjustment component 210 drives, via a driving mechanism, the third adjustment component 230 to achieve pitch adjustment of the carrier assembly 100 with precisely controllable angles. The second adjustment component 220 is linked with the first adjustment component 210 to achieve horizontal displacement adjustment of the carrier assembly 100. The third adjustment component 230 drives the carrier assembly 100 to perform horizontal rotation. This allows for full-range shooting angle adjustment.

When switched to an electromagnetic damping mode, the control assembly 110 alters the energization modes of the motors, allowing the first adjustment component 210, the second adjustment component 220, and the third adjustment component 230 to generate appropriate electromagnetic damping forces and thereby establishing a damping equilibrium state. In this state, an operator may manually adjust the position of the gimbal, and the gimbal will maintain a stable posture.

In some embodiments, the control assembly 110 includes a wireless communication module configured to support remote operation via mobile devices. This allows for remote control and mode switching, significantly enhancing ease of use. The switching between the operating modes is enabled by a built-in mode selection program in the control assembly 110, achieving a seamless switching.

In the embodiments of the present disclosure, the coordinated operation of the three adjustment components allows for omnidirectional adjustment of the carrier assembly 100 in pitch, horizontal displacement, and horizontal rotation, greatly enhancing the shooting freedom of the photographic apparatus 600. Further, the precise control exerted by the control assembly 110 over the three adjustment components ensures not only stable motion in the motorized mode but also enables a flexible manual adjustment in the electromagnetic damping mode, thereby suiting various shooting needs. Moreover, the provision of remote-control capability broadens the application scenarios and increases operational ease of use.

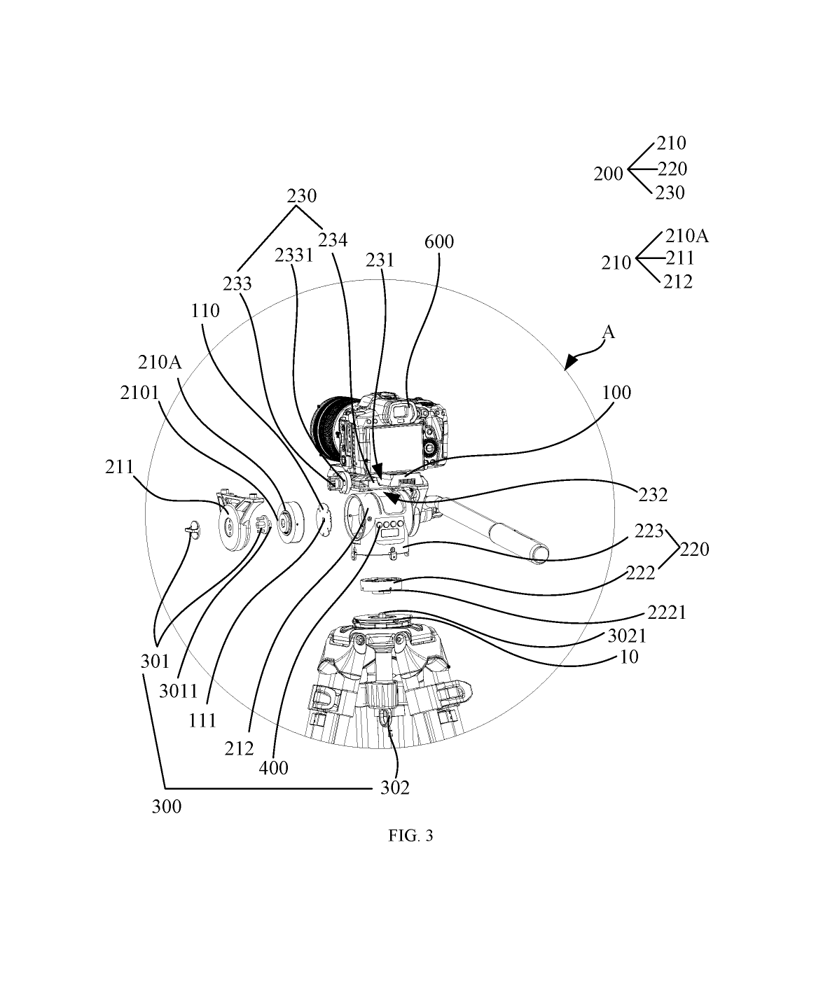

With further reference to FIG. 3, in some embodiments, the first adjustment component 210 includes a first driving member 210A, a first mounting member 211, and a second mounting member 212 rotatable relative to the first mounting member 211. The first driving member 210A is mounted on one of the first mounting member 211 and the second mounting member 212. The first driving member 210A includes an actuating end 2101, and its actuating end 2101 is connected to the other of the first mounting member 211 and the second mounting member 212. The first driving member 210A is electrically connected to the control assembly 110 and configured to apply electromagnetic damping to the relative rotation between the first mounting member 211 and the second mounting member 212.

In the embodiments, the first adjustment component 210 features a dual-member structure, including the first driving member 210A, the first mounting member 211, and the second mounting member 212 rotatable relative to the first mounting member 211. The first driving member 210A is mounted on either one of the first mounting member 211 and the second mounting member 212, and its actuating end 2101 is connected to the other of the first mounting member 211 and the second mounting member 212 on which the first driving member 210A is not mounted, forming a complete drive transmission system. The first driving member 210A is electrically connected to the control assembly 110 for signal transmission and control. This connection allows the control assembly 110 to precisely control the operating state of the first driving member 210A, thereby providing an adjustable electromagnetic damping force to the relative rotation between the first mounting member 211 and the second mounting member 212.

When the control assembly 110 sends a control signal to the first driving member 210A, the first driving member 210A is configured to generate a corresponding electromagnetic damping force based on the control signal. The electromagnetic damping force acts on the relative motion between the first mounting member 211 and the second mounting member 212, realizing continuous adjustment between a free rotation and a fully locked state. This not only provides smooth damping effects but also allows flexible adjustment of the damping level according to practical requirements, thereby securing the stability of controlling the photographic apparatus 600.

In the embodiments of the present disclosure, the dual-member structure being capable of relative rotation provides a more flexible mounting solution and greater adjustment freedom. Further, the implementation of electromagnetic damping overcomes the drawbacks of conventional mechanical damping including susceptibility to wear and inconvenient adjustment, thereby enabling more precise and controllable damping adjustment. Moreover, the configuration features fast response and low noise, making it well-suited for professional photographic applications.

With further reference to FIG. 3, in some embodiments, the second adjustment component 220 includes a second driving member 222 and a third mounting member 223 that is rotatable relative to the base 10. The second driving member 222 is mounted on one of the third mounting member 223 and the base 10. The second driving member 222 includes an actuating end 2221, and its actuating end 2221 is connected to the other of the third mounting member 223 and the base 10. The second driving member 222 is electrically connected to the control assembly 110 and configured to apply electromagnetic damping to the relative rotation between the third mounting member 223 and the base 10.

In the embodiments, the second adjustment component 220 features a base-connection structure, including the second driving member 222 and the third mounting member 223 that is rotatable relative to the base 10. The second driving member 222 is mounted on either one of the third mounting member 233 and the base 10 according to actual installation requirements, and its actuating end 2221 is connected to the other of the third mounting member 233 and the base 10 on which the second driving member 222 is not mounted. The second driving member 222 is electrically connected to the control assembly 110 to achieve electromagnetic damping control over the relative rotation between the third mounting member 223 and the base 10, thereby establishing a stable and reliable motion foundation for the gimbal.

During operation, when the control assembly 110 sends a control signal to the second driving member 222, the second driving member 222 generates a precisely controllable electromagnetic damping force. The electromagnetic damping force acts directly on the relative rotation between the third mounting member 223 and the base 10, realizing continuous adjustment between a complete freedom and a rigidly locked state. This allows an operator to flexibly adjust the damping level according to requirements of different shooting scenarios, ensuring that the photographic apparatus maintains ideal stability under various operational conditions.

With further reference to FIG. 3, in some embodiments, the third adjustment component 230 includes a third driving member 233 and a fourth mounting member 234. The third driving member 233 is mounted on the fourth mounting member 234. The third driving member 233 includes an actuating end 2331, and its actuating end 2331 is connected to the carrier assembly 100. The third driving member 233 is further electrically connected to the control assembly 110 and configured to apply electromagnetic damping to the relative movement of the carrier assembly 100 to the fourth mounting member 234.

In the embodiments, the third adjustment component 230 features a direct-drive structure, including the third driving member 233 and the fourth mounting member 234. The third driving member 233 is directly mounted on the fourth mounting member 234, and its actuating end 2331 is connected to the carrier assembly 100. Moreover, the third driving member 233 is electrically connected to the control assembly 110.

Combined with the first adjustment component 210 and the second adjustment component 220, the electromagnetic damping systems of the three adjustment components work in concert to form a comprehensive and precise control solution. The electromagnetic damping of the first adjustment component 210 is primarily configured for pitch adjustment. Through its dual-member structure, the first adjustment component 210 provides stable damping force during vertical angle changes, effectively preventing sudden dropping or tilting of the photographic device 600. The electromagnetic damping of the second adjustment component 220 is configured for horizontal rotation. By virtue of its connection to the base 10, the second adjustment component 220 ensures continuous and smooth damping during rotational adjustments, effectively suppressing jitter and instability. The electromagnetic damping of the third adjustment component 230 is configured for horizontal displacement control of the carrier assembly 100. By means of direct drive, the third adjustment component 230 supplies precise damping during positional adjustments, effectively eliminating vibration and wobble during movement.

In practice, this three-dimensional electromagnetic damping system enables the operator to dynamically adjust the damping force in each of the three directions via the control assembly 110 when repositioning the photographic apparatus 600. For instance, during tracking shots, the damping force for horizontal rotation may be reduced to allow fluid panning, whereas the forces for pitch and horizontal movement are maintained at higher levels to ensure image stability. For static shots, the damping forces in all directions may be increased simultaneously to securely lock the apparatus in position. This flexible adjustment capability allows for optimal control performance across diverse shooting scenarios.

First, the precise control of the electromagnetic damping forces makes the position-adjustment process smoother, effectively enhancing the stability of captured footage. Second, the damping forces in the three directions can be adjusted independently, providing greater flexibility and adaptability for different shooting scenarios. Third, the electromagnetic damping system responds quickly, enabling more timely and accurate adjustment of the damping forces. Finally, this configuration completely overcomes the limitations of conventional mechanical damping, not only extending the service life of the gimbal but also delivering a better user experience.

Through intelligent coordination of the control assembly 110, the three adjustment components achieve stepless adjustment between complete freedom and a rigidly locked state. This continuously adjustable characteristic offers suitable operational experiences for users, thereby enhancing the versatility and practicality of the gimbal.

In some embodiments, the control assembly 110 is electrically connected to the first driving member 210A, the second driving member 222, and the third driving member 233, respectively.

Under the control of the control assembly 110, the first driving member 210A drives the first mounting member 211 to rotate relative to the second mounting member 212, so as to drive the third adjustment component 230 to perform a pitch motion to adjust the pitch angle of the photographic apparatus 600.

Under the control of the control assembly 110, the second driving member 222 drives the relative rotation between the third mounting member 223 and the base 10, to drive the third adjustment component 230 to perform a horizontal rotation so as to adjust the horizontal angle of the photographic apparatus 600.

Under the control of the control assembly 110, the third driving member 233 drives the carrier assembly 100 to rotate relative to the fourth mounting member 234, so as to adjust the center of gravity of the photographic apparatus 600.

In the embodiments, under the unified coordination of the control assembly 110, the three driving members can not only independently perform their respective adjustment functions but also operate collaboratively to achieve complex comprehensive adjustment effects.

During center-of-gravity adjustment, the coordinated engagement of both the first adjustment component 210 and the second adjustment component 220 is often required to achieve more precise and comprehensive balance control.

The control assembly 110 coordinates the motion states of the three driving members. When adjusting the center of gravity of the photographic apparatus 600, the carrier assembly 100 is controlled, by the third driving member 233, to rotate relative to the fourth mounting member to achieve basic positional adjustment of the center of gravity. The pitch angle is adjusted by the first driving member 210A in a timely manner to compensate for any vertical displacement that may occur during the adjustment process. The horizontal rotation angle is adjusted by the second driving member 222 to ensure balance in the horizontal direction throughout the center-of-gravity adjustment process. The three-dimensional coordinated adjustment ensures smooth and precise center-of-gravity adjustment.

In practical application scenarios, for example, when using an ultra-telephoto lens for shooting, due to the substantial weight and forward-shifted center of gravity of the lens, a comprehensive adjustment mode may be automatically activated. The third driving member 233 first adjusts the position of the carrier assembly 100 to adapt to the weight distribution of the lens. Simultaneously, the first driving member 210A fine-tunes the pitch angle to compensate for the forward-tilting tendency. The second driving member 222 ensures that the entire system remains balance on the horizontal plane. For another instance, during low-angle tracking shots, it is necessary to account for the pitch angle, the horizontal rotation angle, and the center-of-gravity position of the photographic apparatus 600. The three driving members coordinate their operations to ensure that optimal balance is maintained throughout the adjustment process.

When the shooting environment or apparatus configuration changes, the control assembly 110 may automatically calculate and execute the optimal adjustment scheme based on real-time monitoring data. For instance, when shooting in outdoor environments with high wind, the three driving members work in coordination to dynamically adjust the support forces in various directions, thereby ensuring a more stable shooting platform. Through the collaborative operation of the three driving members, the gimbal is capable of adapting to various complex shooting scenarios, offering users more professional and reliable technical support. The gimbal of the present disclosure, by virtue of its comprehensive coordinated control capabilities, endows technical advantages and practical utility in the field of professional photography.

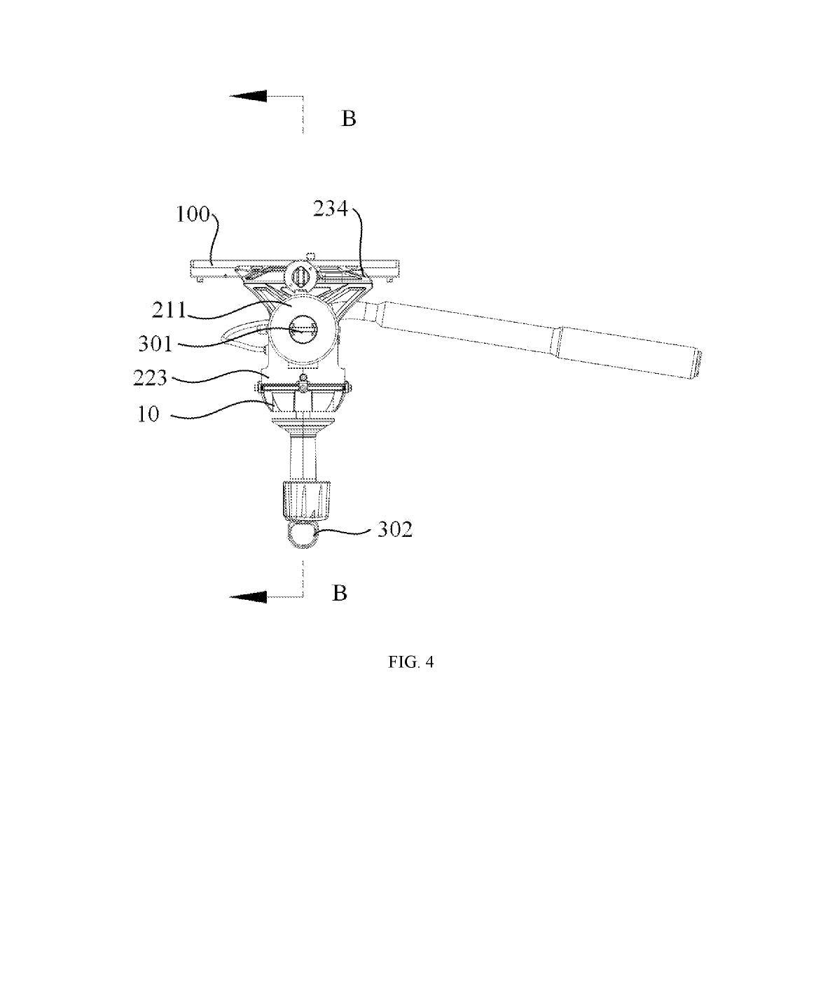

With reference to FIG. 3 to FIG. 5, in some embodiments, the motorized gimbal further includes a clutch mechanism 300. The clutch mechanism 300 is mounted to the adjustment mechanism 200. The clutch mechanism 300 is configured, under an external force, to establish a transmission connection between the first adjustment component 210 and the third adjustment component 230, and to establish a transmission connection between the second adjustment component 220 and the base 10. Alternatively, the clutch mechanism 300 is configured, under an external force, to release a transmission connection between the first adjustment component 210 and the third adjustment component 230, and to release a transmission connection between the second adjustment component 220 and the base 10.

In some embodiments, the clutch mechanism 300 includes a first clutch 301 that is slidably mounted in the first mounting member 211 and fixed relative to the first mounting member 211 in a circumferential direction. The first clutch 301 includes a clutch lever 3011 which can slide along an axial direction of the executing end of the first driving member 210A, to be disengaged from or engaged with the executing end of the first driving member 210A.

In the embodiments, the motorized gimbal further includes the clutch mechanism 300 for realizing flexible switching between different operating modes. The clutch mechanism 300 is disposed within the adjustment mechanism 200 and is mainly configured to control the states of the transmission connections, thereby facilitating switching between the operating modes, including the motorized mode, the electromagnetic damping mode, and the manual mode.

In the embodiments, the first clutch 301 severs as a core component of the clutch mechanism, and the first clutch 301 is slidably received in and engaged with the first mounting member 211. Through its specific structural configuration, the first clutch 301 remains circumferentially fixed relative to the first mounting member 211, and its clutch lever 3011 can slide along the axial direction of the actuating end 2101 of the first driving member 210A to achieve engagement with or disengagement from the actuating end 2101. This provides a reliable mechanical foundation for switching between the operating modes.

When switching to the motorized mode, the clutch lever 3011 of the first clutch 301 is engaged with the actuating end 2101 of the first driving member 210A by an external force, thereby establishing the transmission connection between the first adjustment component 210 and the third adjustment component 230, and also establishing the transmission connection between the second adjustment component 220 and the base 10. In this state, the driving members can directly control the motion of the respective adjustment component, achieving precise electric control. This mode is particularly suitable for shooting scenarios requiring accurate repetitive movements, such as time-lapse photography, and preset-trajectory tracking shots.

When switching to the electromagnetic damping mode, the transmission connections are remained, but the driving members are configured to provide electromagnetic damping forces. In this state, the operator may manually adjust the position of the gimbal while perceiving appropriate damping forces, contributing to smoother motion control.

When switching to the manual mode, the first clutch 301 is disengaged from the actuating end 2101 of the first driving member 210A by an external force, thereby releasing the transmission connection between the first adjustment component 210 and the actuating end 2101 of the first driving member 210A, and also releasing the transmission connection between the second adjustment component 220 and the base 10. In this state, each adjustment component can move freely, allowing the operator to directly and manually adjust the position and angle of the gimbal, which is suitable for quick framing or emergency shooting scenarios.

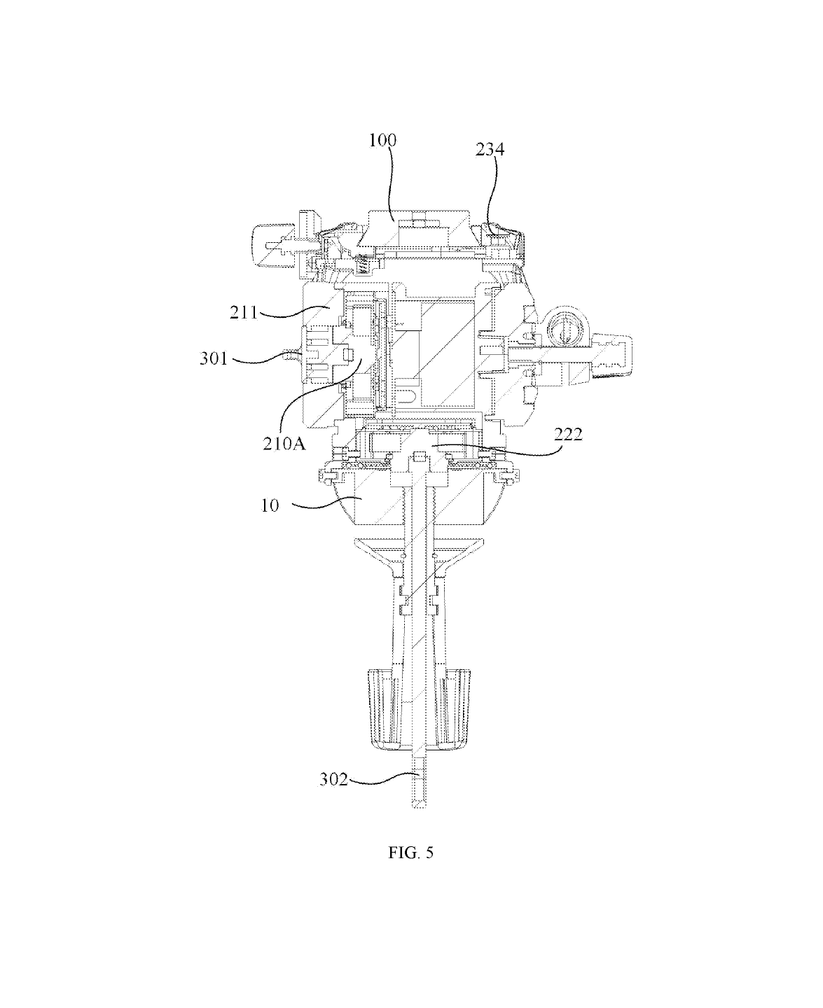

With reference to FIG. 5, in some embodiments, the clutch mechanism 300 further includes a second clutch 302 slidably mounted in the base 10. The second clutch 302 includes a clutch lever 3021 that can slide along an axial direction of the actuating end 2221 of the second driving member 222, so as to be disengaged from or engaged with the actuating end of the second driving member 222.

In the embodiments, the second clutch 302 further refines the mode-switching capability of the gimbal. The second clutch 302 adopts a configuration similar to that of the first clutch 301. The second clutch 302 is slidably mounted in the base 10, and its clutch lever 3021 can slide along the axial direction of the actuating end 2221 of the second driving member 222, thereby achieving engagement with or disengagement from the actuating end. This provides a reliable mechanical foundation for motion control in the horizontal direction.

When an external force is applied to the second clutch 302, the transmission connection is established between the clutch lever 3021 of the second clutch 302 and the actuating end 2221 of the second driving member 222, thereby forming a stable transmission relationship between the base 10 and the second driving member 222. This connection lays the foundation for subsequent horizontal rotation control, thereby enabling the implementation of either the motorized mode or the electromagnetic damping mode according to different operational requirements. In the motorized mode, the second driving member 222 can precisely control the horizontal rotation angle and speed of the gimbal; and in the electromagnetic damping mode, appropriate damping force is generated through the second driving member 222 to ensure smoothness during the horizontal rotation process.

In the embodiments, the coordinated operation of the first clutch 301 and the second clutch 302 allows for more precise and flexible mode switching. For example, during panoramic shooting, the motorized control of the second clutch 302 may be individually activated to achieve constant-speed horizontal rotation. During follow-shot photography, the electromagnetic damping functions of both the first clutch 301 and the second clutch 302 can be utilized simultaneously to ensure smooth motion in all directions. This flexible control approach significantly enhances the practicality of the gimbal, enabling it to better adapt to diverse shooting requirements.

In practical applications, the operator may quickly switch the control mode in the horizontal direction by applying an external force according to shooting requirements, which not only ensures operational convenience but also maintains control precision. This is particularly beneficial in scenarios requiring frequent switching between shooting modes, thereby enhancing operational efficiency.

Referring to FIG. 3, in some embodiments, the motorized gimbal further includes an operation assembly 400. The operation assembly 400 is mounted on one of the first adjustment component 210, the second adjustment component 220, and the third adjustment component 230. The operation assembly 400 is electrically connected to the control assembly 110 and is configured for a user to operate.

In the embodiments, the motorized gimbal further includes the operation assembly 400, which is mounted on one of the first adjustment component 210, the second adjustment component 220, and the third adjustment component 230. The operation assembly 400 is also electrically connected to the control assembly 110. This provides users with a convenient local control interface, enhancing both operational ease and control accuracy.

In some embodiments, in a local control mode, the operation assembly 400 provides flexible and diverse control schemes. Users may select a single-component control mode according to actual needs to precisely adjust the operating state of an individual adjustment component via the operation assembly 400. For instance, when fine-tuning the pitch angle, the first adjustment component 210 may be controlled independently; when adjusting the horizontal angle, the second adjustment component 220 may be controlled independently; and when fine-adjusting the center-of-gravity position, the third adjustment component 230 may be controlled independently. This provides more accurate and convenient detail adjustments during the shooting process.

In some embodiments, the operation assembly 400 may further be provided with a one-touch integrated control function, such as an automatic center-of-gravity adjustment function. Upon one-touch activation via the operation assembly 400, the control assembly 110 automatically coordinates the motion states of the three drive members to achieve intelligent center-of-gravity adjustment. During this process, factors such as the weight distribution and current posture of the photographic apparatus 600 are comprehensively considered, an optimal adjustment scheme is automatically calculated, and the desired center-of-gravity position is rapidly achieved through the coordinated movement of the three driving members.

The operation assembly 400 enables rapid switching between the operating modes of the gimbal. Through simple button operations, users can switch among the motorized mode, the electromagnetic damping mode, and the manual mode. This is particularly useful in complex shooting scenarios. For instance, during news reporting, a photographer may need to quickly alternate between follow-shot and fixed-point shooting. The fast-response characteristics of the operation assembly 400 ensures these transitions happen in moments, preventing the loss of any important shot.

Referring to FIG. 1, in some embodiments, the control assembly 110 further includes a wireless communication module 111 configured to receive an external wireless control signal. In some embodiments, the wireless communication module 111 includes a signal receiver 112 mounted on the second adjustment component 220. The signal receiver 112 is electrically connected to the control assembly 110.

In the embodiments, by integrating the wireless communication module 111 into the control assembly 110, the motorized gimbal achieves remote control functionality. The signal receiver 112 is mounted on the outer surface of the second adjustment component 220, which not only ensures stable signal reception but also minimizes signal interference to the greatest extent possible.

A reliable electrical connection is established between the signal receiver 112 and the control assembly 110, enabling remote control signals to be accurately translated into control commands. Thus, the operator can control the gimbal remotely from a distance. This remote-control functionality offers significant advantages in practical applications. In scenarios such as aerial photography, filming in hazardous environments, or wildlife photography where distance must be maintained, the operator may control the gimbal remotely from a safe location. This ensures both high-quality shooting results and operator safety.

In some embodiments, the wireless communication module 1111 further includes a signal transmitter to enhance the functional completeness of the remote control. The signal transmitter is configured to provide real-time feedback of the operational status of the gimbal to the operator. This data may include key parameters such as the current pitch angle, horizontal rotation angle, center-of-gravity position status, battery level, and the like. This two-way communication mechanism significantly enhances the accuracy and reliability of remote control.

For example, during remote center-of-gravity adjustment, the operator may accurately assess the adjustment effect based on received real-time data and make timely modifications. In complex tracking shots, real-time feedback on current motion parameters is provided to the operator, assisting the operator in making more precise control decisions. Such a real-time data feedback mechanism not only enhances the accuracy of remote control but also delivers more reliable technical support for professional shooting.

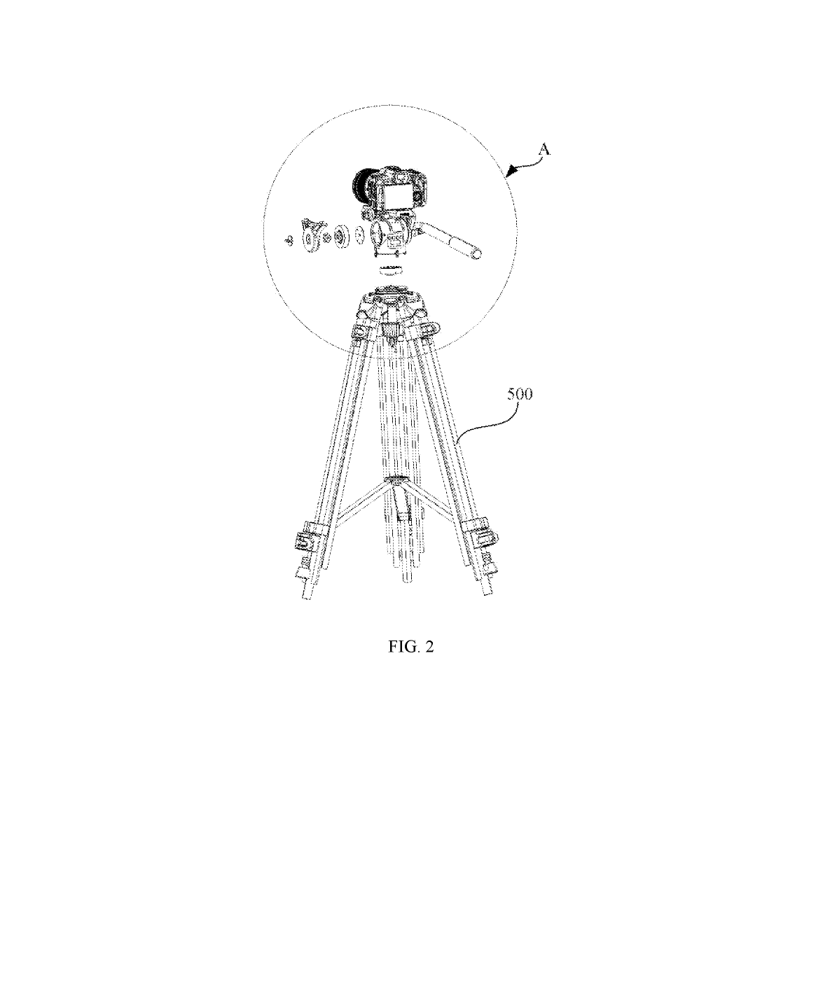

With reference to FIG. 2 and FIG. 3, the present disclosure further provides a photographic device which includes a support frame 500, the photographic apparatus 600, and the motorized gimbal according to any of the foregoing embodiments. The motorized gimbal includes one end connected to the support frame 500, and the other end of the motorized gimbal is connected to the photographic apparatus 600. The specific structure of the motorized gimbal refers to the foregoing embodiments. Since the photographic device adopts all the technical solutions of all the foregoing embodiments, it therefore has at least all the technical effects brought about by the technical solutions of those embodiments, which is not detailed herein.

The photographic device provided herein integrates the aforementioned motorized gimbal with the support frame 500 and the photographic apparatus 600, thereby constructing a complete photographic system solution. In this solution, the motorized gimbal functions as a core connecting component. It is reliably connected at one end to the support frame 500 to provide a stable support base, and at the other end to the photographic apparatus 600, enabling precise control of the latter through its precision adjustment mechanism 200.

The photographic device enables rapid switching between the motorized mode, the electromagnetic damping mode, and the manual mode to suit diverse professional scenarios. For instance, the motorized mode provides precise motion control for commercial photography; the electromagnetic damping mode, with its tunable damping force, ensures smooth footage during rapid tracking shots; and the manual mode allows for immediate posture adjustment in emergencies. This flexibility ensures optimal adaptation to varying shooting demands.

The above are only some embodiments of the present disclosure, and neither the words nor the drawings can limit the protection scope of the present disclosure. Any equivalent structural transformation made by using the contents of the specification and the drawings of the present disclosure under the overall concept of the present disclosure, or directly/indirectly applied in other related technical fields are included in the protection scope of the present disclosure.

What is claimed is:

1. A motorized gimbal, comprising:
a base;
a carrier assembly configured to mount a photographic apparatus;
an adjustment mechanism disposed on the base, the adjustment mechanism comprising a first adjustment component, a second adjustment component, and a third adjustment component comprising a first end and a second end; wherein,
the first end of the third adjustment component is connected to the carrier assembly, and the third adjustment component is configured to drive the carrier assembly to rotate in a horizontal direction;
the first adjustment component is connected to the second end of the third adjustment component and configured to drive the third adjustment component to drive the carrier assembly to perform a pitch motion; and
the second adjustment component is connected to the first adjustment component and configured to drive the first adjustment component so as to drive the third adjustment component to move in a horizontal direction; and
a control assembly electrically connected to the first adjustment component, the second adjustment component, and the third adjustment component respectively, the control assembly being configured to control an operating state of at least one selected from a group consisting of the first adjustment component, the second adjustment component, and the third adjustment component.

2. The motorized gimbal of claim 1, wherein the first adjustment component comprises a first driving member, a first mounting member, and a second mounting member rotatable relative to the first mounting member; wherein,
the first driving member is mounted on one of the first mounting member and the second mounting member, and the first driving member comprises an actuating end that is connected to the other of the first mounting component and the second mounting component; and
the first driving member is electrically connected to the control assembly and configured to apply electromagnetic damping to relative rotation between the first mounting member and the second mounting member.

3. The motorized gimbal of claim 2, wherein the second adjustment component comprises a second driving member and a third mounting member rotatable relative to the base; wherein,
the second driving member is mounted on one of the third mounting member and the base, and the second driving member comprises an actuating end that is connected to the other of the third mounting component and the base; and
the second driving member is electrically connected to the control assembly and configured to apply electromagnetic damping to relative rotation between the third mounting member and the base.

4. The motorized gimbal of claim 3, wherein the third adjustment component comprises a third driving member and a fourth mounting member; wherein,
the third driving member is mounted on the fourth mounting member, and the third driving member comprises an actuating end that is connected to the carrier assembly; and
the third driving member is electrically connected to the control assembly and configured to apply electromagnetic damping to relative movement between the carrier assembly and the fourth mounting member.

5. The motorized gimbal of claim 4, wherein the control assembly is electrically connected to the first driving member, the second driving member, and the third driving member, respectively; wherein,
the first driving member is configured to, under control of the control assembly, drive the first mounting member to rotate relative to the second mounting member, to drive the third adjustment component to perform a pitch motion so as to adjust a pitch angle of the photographic apparatus;
the second driving member is configured to, under control of the control assembly, drive the relative rotation between the third mounting member and the base, to drive the third adjustment component to perform a horizontal rotation so as to adjust a horizontal angle of the photographic apparatus; and
the third driving member is configured to, under control of the control assembly, drive the carrier assembly to rotate relative to the fourth mounting member so as to adjust a center of gravity of the photographic apparatus.

6. The motorized gimbal of claim 3, further comprising a clutch mechanism mounted to the adjustment mechanism; wherein,
the clutch mechanism is configured to, under action of an external force,
establish a transmission connection between the first adjustment component and the third adjustment component, and establish a transmission connection between the second adjustment component and the base; or
release a transmission connection between the first adjustment component and the third adjustment component, and release a transmission connection between the second adjustment component and the base; and
the clutch mechanism comprises:
a first clutch slidably mounted in the first mounting member and fixed relative to the first mounting member in a circumferential direction;
wherein the first clutch comprises a clutch lever slidable along an axial direction of the actuating end of the first driving member, so as to disengage from or engage with the actuating end of the first driving member.

7. The motorized gimbal of claim 6, wherein the clutch mechanism further comprises a second clutch slidably mounted in the base; wherein,
the second clutch comprises a clutch lever slidable along an axial direction of the actuating end of the second driving member, so as to disengage from or engage with the actuating end of the second driving member.

8. The motorized gimbal of claim 1, further comprising an operation assembly;
wherein the operation assembly is disposed on one of the first adjustment component, the second adjustment component, and the third adjustment component; and the operation assembly is electrically connected to the control assembly and configured for a user to operate.

9. The motorized gimbal of claim 1, wherein the control assembly comprises a wireless communication module configured to receive an external wireless control signal.

10. The motorized gimbal of claim 9, wherein the wireless communication module comprises a signal receive; wherein the signal receive is disposed on the second adjustment component and electrically connected to the control assembly.

11. A photographic device, comprising:
a support frame;
a photographic apparatus; and
the motorized gimbal according to claim 1;
wherein one end of the motorized gimbal is connected to the support frame, and the other end of the motorized gimbal is connected to the photographic apparatus.

12. The photographic device of claim 11, wherein the first adjustment component comprises a first driving member, a first mounting member, and a second mounting member rotatable relative to the first mounting member; wherein,
the first driving member is mounted on one of the first mounting member and the second mounting member, and the first driving member comprises an actuating end that is connected to the other of the first mounting component and the second mounting component; and
the first driving member is electrically connected to the control assembly and configured to apply electromagnetic damping to relative rotation between the first mounting member and the second mounting member.

13. The photographic device of claim 12, wherein the second adjustment component comprises a second driving member and a third mounting member rotatable relative to the base; wherein,
the second driving member is mounted on one of the third mounting member and the base, and the second driving member comprises an actuating end that is connected to the other of the third mounting component and the base; and
the second driving member is electrically connected to the control assembly and configured to apply electromagnetic damping to relative rotation between the third mounting member and the base.

14. The photographic device of claim 13, wherein the third adjustment component comprises a third driving member and a fourth mounting member; wherein,
the third driving member is mounted on the fourth mounting member, and the third driving member comprises an actuating end that is connected to the carrier assembly; and
the third driving member is electrically connected to the control assembly and configured to apply electromagnetic damping to relative movement between the carrier assembly and the fourth mounting member.

15. The photographic device of claim 14, wherein the control assembly is electrically connected to the first driving member, the second driving member, and the third driving member, respectively; wherein,
the first driving member is configured to, under control of the control assembly, drive the first mounting member to rotate relative to the second mounting member, to drive the third adjustment component to perform a pitch motion so as to adjust a pitch angle of the photographic apparatus;
the second driving member is configured to, under control of the control assembly, drive the relative rotation between the third mounting member and the base, to drive the third adjustment component to perform a horizontal rotation so as to adjust a horizontal angle of the photographic apparatus; and
the third driving member is configured to, under control of the control assembly, drive the carrier assembly to rotate relative to the fourth mounting member so as to adjust a center of gravity of the photographic apparatus.

16. The photographic device of claim 13, further comprising a clutch mechanism mounted to the adjustment mechanism; wherein,
the clutch mechanism is configured to, under action of an external force,
establish a transmission connection between the first adjustment component and the third adjustment component, and establish a transmission connection between the second adjustment component and the base; or
release a transmission connection between the first adjustment component and the third adjustment component, and release a transmission connection between the second adjustment component and the base; and
the clutch mechanism comprises:
a first clutch slidably mounted in the first mounting member and fixed relative to the first mounting member in a circumferential direction;
wherein the first clutch comprises a clutch lever slidable along an axial direction of the actuating end of the first driving member, so as to disengage from or engage with the actuating end of the first driving member.

17. The photographic device of claim 16, wherein the clutch mechanism further comprises a second clutch slidably mounted in the base; wherein,
the second clutch comprises a clutch lever slidable along an axial direction of the actuating end of the second driving member, so as to disengage from or engage with the actuating end of the second driving member.

18. The photographic device of claim 11, further comprising an operation assembly;
wherein the operation assembly is disposed on one of the first adjustment component, the second adjustment component, and the third adjustment component; and the operation assembly is electrically connected to the control assembly and configured for a user to operate.

19. The photographic device of claim 11, wherein the control assembly comprises a wireless communication module configured to receive an external wireless control signal.

20. The photographic device of claim 19, wherein the wireless communication module comprises a signal receive; wherein the signal receive is disposed on the second adjustment component and electrically connected to the control assembly.
